(19) United States
(12) Patent Application Publication
(10) Pub. No.: US 2026/0304194 A1
(43) Pub. Date: Oct. 1, 2026

(54) ENHANCEMENTS ON CSI FRAMEWORK

(71) Applicant: Nokia Technologies Oy, Espoo (FI)

(72) Inventors: Matha DEGHEL, Massy (FR); Keeth Saliya Jayasinghe LADDU, Espoo (FI)

(21) Appl. No.: 19/490,992

(22) PCT Filed: Jun. 9, 2024
(86) PCT No.: PCT/IB2024/055635

§ 371 Date: Dec. 8, 2025

Related U.S. Application Data
(60) Provisional application No. 63/472,013, filed on Jun. 9, 2023.

(51) Int. Cl. H04W 24/10

(52) U.S. Cl. CPC H04W 24/10

(57) ABSTRACT

In accordance with example embodiments of the invention there is at least a method and apparatus to perform receiving, by a network device from a network node of a communication network, at least one channel state information report configuration associated with at least one uplink resource; determining from measurements performed based at least in part on the at least one channel state information report configuration that at least one event has occurred; and providing over the at least one uplink resource the network node with information comprising an indication that the event has occurred. Further, to perform transmitting, by a network node for a network device of a communication network, at least one channel state information report configuration associated with at least one uplink resource, wherein measurements are performed by the network device based at least in part on the at least one channel state information report configuration for determining that at least one event has occurred; and receiving over the at least one uplink resource information comprising an indication that the at least one event occurred, wherein the information is based at least partially on the channel state information report configuration.

### TECHNICAL FIELD

The teachings in accordance with the exemplary embodiments of this invention relate generally to a new method and apparatus to use UL resources to configure, define, and/or indicate to UE and, more specifically, relate to a new and apparatus to configure, define and/or indicate to UE UL resources to use in order to provide the gNB with information related to an event such as related to beam and/or CSI events.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
5 5^{th} Generation
CORESET Control Resource Set
CQI Channel Quality Indicator
C-RNTI Cell Radio-Network Temporary Identifier
CRI CSI-RS resource indicator
CSI Channel State Information
CSI-RS Channel State Information Reference Signal
DCI Downlink Control Information
DL Downlink
DMRS demodulation reference signal
FR 1 Frequency Range 1
gNB 5G/NR base station
HARQ Hybrid Automatic Repeat request
HARQ-ACK HARQ Acknowledgment
MAC Medium Access Control
MAC CE Medium Access Control Control Element
MPE Maximum Permissible Exposure
NR New Radio
PCI physical cell identity
PDCCH Physical Downlink Control Channel
PDSCH Physical Downlink Shared Channel
PUCCH Physical Uplink Control Channel
PUSCH Physical Uplink Shared Channel
RAN Radio Access Network
RS Reference Signal
RNTI Radio-Network Temporary Identifier
RSRP Reference Signal Received Power
SINR Signal to Information Noise Ratio
SR Scheduling Request
SRS Sounding Reference Signal
SRI SRS resource indicator
SSB Synchronization Signal Block
TCI Transmission Configuration Indicator
TRP Transmission-Reception Point
UCI Uplink Control Information
UE User Equipment
UL Uplink

Wireless communication systems are widely deployed to provide various telecommunication services such as telephone operations, video, data, messaging, and broadcasts. Typical wireless communication systems may employ multiple-access technologies capable of supporting communication with multiple users by sharing available system resources (e.g., bandwidth, transmit power, etc.). Examples of such multiple-access technologies include time division multiple access (TDMA) systems, frequency division multiple access (FDMA) systems, code division multiple access (CDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard disseminated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. These telecommunications standards include new Radio (NR), which may be referred to as 5G, or 6G which includes a set of enhancements to at least the LTE mobile standard promulgated by the 3GPP. 5G and 6G are designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, 5G, and 6G communication technologies and other radio access technologies remain useful.

It is noted that for these technologies some of the resource elements carry reference (pilot) signals (RS) for the UE. These RSs may include demodulation RS (DM-RS), SSBs, channel state information reference signals (CSI-RS) e.g., for channel estimation at the UE for one particular configuration.

CSI-RS reference signals are configured in RRC for a UE. However, CSI-RS reference signals can be shared among many UEs, and the RS may also include beam measurement RS, beam refinement RS, and phase tracking RS (PT-RS) or tracking reference signal (TRS).

Example embodiments of this invention proposes improved at least these CSI-RS operations.

### SUMMARY

This section contains examples of possible implementations and is not meant to be limiting.

In another example aspect of the invention, there is an apparatus, such as a user equipment side apparatus, comprising: at least one processor; and at least one non-transitory memory storing instructions, that when executed by the at least one processor, cause the apparatus at least to: receive, by a network device from a network node of a communication network, at least one channel state information report configuration associated with at least one uplink resource; determine from measurements performed based at least in part on the at least one channel state information report configuration that at least one event has occurred; and provide over the at least one uplink resource the network node with information comprising an indication that the event has occurred.

In still another example aspect of the invention, there is a method, comprising: receiving, by a network device from a network node of a communication network, at least one channel state information report configuration associated with at least one uplink resource; determining from measurements performed based at least in part on the at least one channel state information report configuration that at least one event has occurred; and providing over the at least one uplink resource the network node with information comprising an indication that the event has occurred.

A further example embodiment is an apparatus and a method comprising the apparatus and the method of the previous paragraphs, wherein there is performing the measurements based at least in part on the at least one channel state information report configuration.

A further example embodiment is an apparatus and a method comprising the apparatus and the method of the previous paragraphs, wherein the performing is based on reference signal resources corresponding to the at least one channel state information report configuration; and determining based on the measurements that the at least one event has occurred.

A further example embodiment is an apparatus and a method comprising the apparatus and the method of the previous paragraphs, wherein there is determining the at least one uplink resource is active based on the at least one channel state information report configuration being triggered or activated for the network device.

A further example embodiment is an apparatus and a method comprising the apparatus and the method of the previous paragraphs, wherein the at least one uplink resource is configured with at least one of a periodicity or offset, or the at least one uplink resource is aperiodic.

A further example embodiment is an apparatus and a method comprising the apparatus and the method of the previous paragraphs, wherein the at least one uplink resource is triggered or activated for a period of time, or after a timer expires, or a period of time or an offset after the at least one channel state information report configuration is triggered or activated, or after or when the at least one channel state information report configuration is triggered or activated, or after or when the at least one event has occurred.

A further example embodiment is an apparatus and a method comprising the apparatus and the method of the previous paragraphs, wherein the triggering or activating is performed via at least one of: a downlink control information, a medium access control control element, or radio resource control signaling.

A further example embodiment is an apparatus and a method comprising the apparatus and the method of the previous paragraphs, wherein a reference point for the at least one of a period of time or an offset is based on a physical downlink control channel or a physical downlink shared channel carrying a downlink control information or a medium access control control element triggering the at least one channel state information report configuration.

A further example embodiment is an apparatus and a method comprising the apparatus and the method of the previous paragraphs, wherein the information provided over the at least one uplink resource to the network node comprises at least one of the at least one event occurring, or a beam information report, or a channel state information report.

A further example embodiment is an apparatus and a method comprising the apparatus and the method of the previous paragraphs, wherein when at least one of the at least one event occurs, the network device is configured to use the at least one uplink resource for carrying information of at least one of: that at least one of the at least one event has occurred, or a beam report or channel state information report, a beam related report or channel state information related report.

A further example embodiment is an apparatus and a method comprising the apparatus and the method of the previous paragraphs, wherein the information comprises uplink control information.

A further example embodiment is an apparatus and a method comprising the apparatus and the method of the previous paragraphs, wherein the network device is configured to separately encode different parts of the information.

A further example embodiment is an apparatus and a method comprising the apparatus and the method of the previous paragraphs, wherein a number of bits the information or each part of the information consumes is configured or indicated for the network device via medium access control control element, downlink control information or radio resource control signaling.

A further example embodiment is an apparatus and a method comprising the apparatus and the method of the previous paragraphs, wherein a number of bits the information consumes is configured for the network device via radio resource control.

A further example embodiment is an apparatus and a method comprising the apparatus and the method of the previous paragraphs, wherein the information is encoded to provide separate information of more than one event, and wherein a number of bits each separate information is configured or indicated for the network device via medium access control control element, downlink control information or radio resource control signaling.

A further example embodiment is an apparatus and a method comprising the apparatus and the method of the previous paragraphs, wherein different or separate uplink resources are used to provide the network node with different parts of the information.

A further example embodiment is an apparatus and a method comprising the apparatus and the method of the previous paragraphs, wherein the information comprises information of one or more of: at least one first event occurring, at least one second event not occurring, a beam report or a channel state information report for the at least one first event, a beam report or a channel state information report for the at least one second event, at least one event occurring, and an indication of a corresponding cell or a corresponding component carrier, at least one event not occurring, and an indication of a corresponding cell or a corresponding component carrier, at least one event occurring, and an indication of a corresponding CSI report configuration, at least one event not occurring, an indication of a corresponding CSI report configuration, an indication that the at least one event has occurred, a beam reporting or a triggering of a beam reporting, a beam or transmission configuration indicator state update or change, or triggering beam or transmission configuration indicator state update or change, a channel state information update or change, or triggering channel state information update or change, or measurements for one or more beams or transmission configuration indicator states, or a reference signal received power or signal to interference noise ratio being below or above a threshold, or a triggering of or a request for beam refinement, or at least one best or preferred beam or at least one best or preferred transmission configuration indicator, or at least one event occurring, and an indication of a corresponding reference signal resource group, or at least one event not occurring, and an indication of a corresponding reference signal resource group, or at least one event occurring, and an indication of a corresponding control resource set pool index or a corresponding physical cell identity or a corresponding sounding reference signal resource set or a corresponding transmission-reception point or a corresponding group of beams or a corresponding group of reference signals, or at least one event not occurring, and an indication of a corresponding control resource set pool index or a corresponding physical cell identity or a corresponding sounding reference signal resource set or a corresponding transmission-reception point or a corresponding group of beams or a corresponding group of reference signals.

A further example embodiment is an apparatus and a method comprising the apparatus and the method of the previous paragraphs, wherein the at least one uplink resource comprises two or more resources, wherein a time offset is defined between the resources, and wherein a first resource in a first slot or a first sub-slot is for carrying a first part of the information and a second resource in a second slot or a second sub-slot is for carrying a second part of the information.

A further example embodiment is an apparatus and a method comprising the apparatus and the method of the previous paragraphs, wherein the at least one uplink resource comprises two or more resources.

A further example embodiment is an apparatus and a method comprising the apparatus and the method of the previous paragraphs, wherein the first resource corresponds to or is associated with a first channel state information reference signal resource set or group and the second resource corresponds to or is associated with a second channel state information reference signal resource set or group.

A further example embodiment is an apparatus and a method comprising the apparatus and the method of the previous paragraphs, wherein at least one event is determined to have occurred by the network device based on measurements performed for each reference signal resource set or group separately, or by jointly considering both resource sets or groups.

A further example embodiment is an apparatus and a method comprising the apparatus and the method of the previous paragraphs, wherein each uplink resource or channel state information reference signal resource set or group corresponds to or is associated with one or more of: a transmission-reception point, control resource set pool index, a sounding reference signal resource set, a physical cell identity.

A further example embodiment is an apparatus and a method comprising the apparatus and the method of the previous paragraphs, wherein when at least one event is determined to have occurred based on measurements performed for a resource set or group, the apparatus is caused to use at least one uplink resource associated with the resource set or group to provide the information or at least part of the information to the network node.

A further example embodiment is an apparatus and a method comprising the apparatus and the method of the previous paragraphs, wherein the at least one event comprises one or more of: a network device decision on transmission configuration indicator state change or a beam switch, a change of one or more of a number of best or preferred beams for reporting, a change of one or more of a number of best or preferred beam pairs for reporting, a beam or transmission configuration indicator state quality-related condition is satisfied, a change of at least one channel state information quantity, or a maximum permissible exposure value is above a certain threshold.

A further example embodiment is an apparatus and a method comprising the apparatus and the method of the previous paragraphs, wherein the at least one event comprises one or more of: a change in a best beam, or a change in a best channel state information reference signal resource indicator (CRI), or a change in a best synchronization signal block resource indicator (SSBRI), or a change in a set of one or more best beams, or a change in a set of one or more best channel state information reference signal resource indicators (CRIs), or a change in a set of one or more best synchronization signal block resource indicators (SSBRIs), or a change of at least one of a set of best beam pairs or channel state information reference signal resource indicator (CRI) pairs, or a reference signal received power (RSRP) value associated with a best beam or at least one of the set of best beams or at least one beam pair is lower or higher than a threshold or changes more than an offset value, or a value related to reference signal received power values associated with at least part of the set of best beams or at least part of least one beam pair is lower or higher than a threshold or changes more than an offset value, or a measurement value of at least one reference signal (RS) associated with a transmission configuration indication (TCI) state is higher or lower than a measurement value of a reference signal (RS) associated with another TCI state by a threshold, or a reference signal received power value associated with a transmission configuration indication state is lower 1.

A further example embodiment is an apparatus and a method comprising the apparatus and the method of the previous paragraphs, wherein there is determining that the at least one uplink resource is invalid or inactive when the at least one channel state information report configuration is deactivated or not active, or determining that the at least one uplink resource is invalid or inactive when event-based reporting or triggering is deactivated or is not valid.

A further example embodiment is an apparatus and a method comprising the apparatus and the method of the previous paragraphs, wherein the at least one channel state information report configuration corresponds to or includes or can be replaced by at least one of: one or more demodulation reference signal configurations, or one or more physical downlink shared channel configurations, one or more physical downlink shared channel configurations, or one or more channel state information report sub-configuration each of which corresponding to one or more of the at least one events or to at least one condition.

A further example embodiment is an apparatus and a method comprising the apparatus and the method of the previous paragraphs, wherein one or more events of the at least one event is associated with a dedicated one or more uplink resources corresponding to the at least one channel state information report configuration.

A non-transitory computer-readable medium storing program code, the program code executed by at least one processor to perform at least the method as described in the paragraphs above.

In yet another example aspect of the invention, there is an apparatus comprising: means for receiving, by a network device from a network node of a communication network, at least one channel state information report configuration associated with at least one uplink resource; means for determining from measurements performed based at least in part on the at least one channel state information report configuration that at least one event has occurred; and means for providing over the at least one uplink resource the network node with information comprising an indication that the event has occurred.

In accordance with the example embodiments as described in the paragraph above, at least the means for receiving, determining, and providing comprises a network interface, and computer program code stored on a computer-readable medium and executed by at least one processor.

In another example aspect of the invention, there is an apparatus, such as a network side apparatus, comprising: at least one processor; and at least one non-transitory memory storing instructions, that when executed by the at least one processor, cause the apparatus at least to: transmit, by a network node for a network device of a communication network, at least one channel state information report configuration associated with at least one uplink resource, wherein measurements are performed by the network device based at least in part on the at least one channel state information report configuration for determining that at least one event has occurred; and receive over the at least one uplink resource information comprising an indication that the at least one event occurred, wherein the information is based at least partially on the channel state information report configuration, wherein the information is based on the channel state information report configuration.

In still another example aspect of the invention, there is a method, comprising: transmitting, by a network node for a network device of a communication network, at least one channel state information report configuration associated with at least one uplink resource, wherein measurements are performed by the network device based at least in part on the at least one channel state information report configuration for determining that at least one event has occurred; and receiving over the at least one uplink resource information comprising an indication that the at least one event occurred, wherein the information is based at least partially on the channel state information report configuration.

A further example embodiment is an apparatus and a method comprising the apparatus and the method of the previous paragraphs, wherein the measurements are performed based at least in part on one of the at least one channel state information report configuration or reference signal resources corresponding to the at least one channel state information report configuration.

A further example embodiment is an apparatus and a method comprising the apparatus and the method of the previous paragraphs, wherein the at least one uplink resource is triggered or activated for a period of time, or after a timer expires, or a period of time or an offset after the at least one channel state information report configuration is triggered or activated, or after or when the at least one channel state information report configuration is triggered or activated, or after or when the at least one event has occurred.

A further example embodiment is an apparatus and a method comprising the apparatus and the method of the previous paragraphs, wherein the at least one uplink resource is configured with at least one of a periodicity or offset, or the at least one uplink resource is aperiodic.

A further example embodiment is an apparatus and a method comprising the apparatus and the method of the previous paragraphs, wherein the at least one uplink resource is triggered or activated for a period of time, or after a timer expires, or a period of time or an offset after the at least one channel state information report configuration is triggered or activated, or after or when the at least one channel state information report configuration is triggered or activated, or after or when the at least one event has occurred.

A further example embodiment is an apparatus and a method comprising the apparatus and the method of the previous paragraphs, wherein the triggering or activating is performed via at least one of: a downlink control information, a medium access control control element, or radio resource control.

A further example embodiment is an apparatus and a method comprising the apparatus and the method of the previous paragraphs, wherein a reference point for the at least one of a period of time or an offset is based on a physical downlink control channel or a physical downlink shared channel carrying a downlink control information or a medium access control control element triggering the at least one channel state information report configuration, and wherein the information is received over the at least one uplink resource.

A further example embodiment is an apparatus and a method comprising the apparatus and the method of the previous paragraphs, wherein the information comprises at least one of the at least one event occurring, or a beam information report, or a channel state information report.

A further example embodiment is an apparatus and a method comprising the apparatus and the method of the previous paragraphs, wherein the information is encoded to provide separate information of more than one event.

A further example embodiment is an apparatus and a method comprising the apparatus and the method of the previous paragraphs, wherein the more than one event is multiplexed in time.

A further example embodiment is an apparatus and a method comprising the apparatus and the method of the previous paragraphs, wherein a number of bits each separate information is configured or indicated for the network device via medium access control control element, downlink control information or radio resource control signaling.

A further example embodiment is an apparatus and a method comprising the apparatus and the method of the previous paragraphs, wherein different or separate uplink resources are used to receive different parts of the information.

A further example embodiment is an apparatus and a method comprising the apparatus and the method of the previous paragraphs, wherein the information comprises information of one or more of: at least one first event occurring, at least one second event not occurring, a beam report or a channel state information report for the at least one first event, a beam report or a channel state information report for the at least one second event, at least one event occurring, and an indication of a corresponding cell or a corresponding component carrier, at least one event not occurring, and an indication of a corresponding cell or a corresponding component carrier, at least one event occurring, and an indication of a corresponding CSI report configuration, at least one event not occurring, an indication of a corresponding CSI report configuration, an indication that the at least one event has occurred, a beam reporting or a triggering of a beam reporting, a beam or transmission configuration indicator state update or change, or triggering beam or transmission configuration indicator state update or change, a channel state information update or change, or triggering channel state information update or change, or measurements for one or more beams or transmission configuration indicator states, or a reference signal received power or signal to interference noise ratio being below or above a threshold, or a triggering of or a request for beam refinement, or at least one best or preferred beam or at least one best or preferred transmission configuration indicator, or at least one event occurring, and an indication of a corresponding reference signal resource group, or at least one event not occurring, and an indication of a corresponding reference signal resource group, or at least one event occurring, and an indication of a corresponding control resource set pool index or a corresponding physical cell identity or a corresponding sounding reference signal resource set or a corresponding transmission-reception point or a corresponding group of beams or a corresponding group of reference signals, or at least one event not occurring, and an indication of a corresponding control resource set pool index or a corresponding physical cell identity or a corresponding sounding reference signal resource set or a corresponding transmission-reception point or a corresponding group of beams or a corresponding group of reference signals.

A further example embodiment is an apparatus and a method comprising the apparatus and the method of the previous paragraphs, wherein the at least one uplink resource comprises two or more resources, wherein a time offset is defined between the resources, and wherein a first resource in a first slot or a first sub-slot is for carrying a first part of the information and a second resource in a second slot or a second sub-slot is for carrying a second part of the information.

A further example embodiment is an apparatus and a method comprising the apparatus and the method of the previous paragraphs, wherein each at least one uplink resource corresponds to one or more of a transmission-reception point, control resource set pool index, an sounding reference signal resource set, or a physical cell identity, wherein the corresponding enables detection of the at least one event for each transmission-reception point separately or jointly across a transmission-reception point.

A further example embodiment is an apparatus and a method comprising the apparatus and the method of the previous paragraphs, wherein each at least one uplink resource corresponds to one or more of a transmission-reception point of an antenna, control resource set pool index, an SRS resource set, or a physical cell identity.

A further example embodiment is an apparatus and a method comprising the apparatus and the method of the previous paragraphs, wherein the corresponding enables detection of the at least one event for each transmission-reception point of an antenna separately or jointly across a transmission-reception point.

A further example embodiment is an apparatus and a method comprising the apparatus and the method of the previous paragraphs, wherein the at least one event comprises: a network device decision on transmission configuration indicator state change or a beam switch, a change of one or more of a number of best or preferred beams for reporting, a change of one or more of a number of best or preferred beam pairs for reporting, a beam or transmission configuration indicator state quality-related condition is satisfied, a change of at least one channel state information quantity, or a maximum permissible exposure value is above a certain threshold.

A further example embodiment is an apparatus and a method comprising the apparatus and the method of the previous paragraphs, wherein the information comprises at least one of: an indication that the event has occurred, beam reporting or triggering beam reporting, beam or transmission configuration indicator state update or change or triggering such an updateorchange, channel state information update or change or triggering such updateorchange, or measurements for one or more beams or transmission configuration indicator states, such as reference signal received power or signal to interference noise ratio below or above a threshold.

A further example embodiment is an apparatus and a method comprising the apparatus and the method of the previous paragraphs, wherein the at least one channel state information report configuration corresponds to or includes or can be replaced by at least one of: one or more demodulation reference signal configurations, or one or more physical downlink shared channel configurations, one or more physical downlink shared channel configurations, or one or more channel state information report sub-configuration each of which is corresponding to one or more of the at least one events or to at least one condition.

A further example embodiment is an apparatus and a method comprising the apparatus and the method of the previous paragraphs, wherein one or more events of the at least one event is associated with a dedicated one or more uplink resources corresponding to the at least one channel state information report configuration.

A non-transitory computer-readable medium storing program code, the program code executed by at least one processor to perform at least the method as described in the paragraphs above.

In yet another example aspect of the invention, there is an apparatus comprising: means for transmitting, by a network node for a network device of a communication network, at least one channel state information report configuration associated with at least one uplink resource, wherein measurements are performed by the network device based at least in part on the at least one channel state information report configuration for determining that at least one event has occurred; and means for receiving over the at least one uplink resource information comprising an indication that the at least one event occurred, wherein the information is based at least partially on the channel state information report configuration.

In accordance with the example embodiments as described in the paragraph above, at least the means for transmitting and receiving comprises a network interface, and computer program code stored on a computer-readable medium and executed by at least one processor.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows an illustration of some of the high-level aspects of a proposed solutions in accordance with example embodiments of the invention;

FIG. 2 shows a signaling diagram of some of the high-level aspects of another proposed solutions in accordance with example embodiments of the invention;

FIG. 3 shows a high level block diagram of various devices used in carrying out various aspects of the invention; and

FIG. 4A and FIG. 4B each show a method in accordance with example embodiments of the invention which may be performed by an apparatus.

### DETAILED DESCRIPTION

In example embodiments of this invention there is proposed at least a method and apparatus for a new method and apparatus to configure, define and/or indicate to UE UL resources to use in order to provide the gNB with information related to an event such as related to beam and/or CSI events.

CSI-RS reference signals are UE-specifically configured in RRC. However, CSI-RS reference signals can be shared among many UEs, i.e., more than 1 UE are configured to receive the same resource elements (RE).

In general, in order to save on DL resources, the gNB would try to use cell-specific or group-specific CSI-RS resources. The worst case of DL overhead is with UE specific CSI-RS where the DL overhead increases linearly with the number of UEs in the cell.

CSI-RS has many functions in NR, for example it may include:
CSI-RS for DL CSI acquisition;
CSI-RS for beam management (BM) (based on L1-RSRP);
CSI-RS for tracking (TRS);
UL CSI acquisition in reciprocity-based UL precoding.

In some applications (e.g., CSI-RS for BM) CSI-RS are spatially beamformed into different directions.

In general, a UE can be configured with up to 48 report configurations (CSI-ReportConfig) per component carrier (CC)/4 per bandwidth part (BWP)

One CSI resource config within 1 report configuration can be configured with up to 16 resource sets (aperiodic CSI) and 1 resource set (otherwise).

In each CSI resource set up to 64 NZP CSI-RS resources and 1 NZP-CSI-RS resource up to 32 antenna ports.

For CSI acquisition, the UE is configured also with a codebook type. Given the measured channel across a CSI-RS resource, the UE can choose a favourite codeword from the specified codebook, i.e., precoding matrix indicator (PMI), along with channel quality indicator (CQI), rank indicator (RI). UE can also be configured to measure several CSI-RS resources (up to 8) within a resource set and report the favourite resource, CSI-RS resource indicator (CRI), along with PMI, CQI and RI which corresponds to that selected resource.

### Time Domain

In the time domain, a CSI-RS resource may start at any OFDM symbol of a slot and it spans 1, 2, or 4 OFDM symbols depending on the number of ports configured.

Likewise, also the UE measurement reporting of CSI can be also operated with periodic, semi-persistent, or aperiodic manner, which is so-called report types in NR report configuration. However, there are certain limitations, based on which the UE periodic report can operate only based on the configured periodic CSI-RS resource-set, the UE semi-persistent report can operate based on both configured periodic and semi-persistent CSI-RS resource-set, and finally the UE aperiodic report can operate based on all periodic, semi-persistent, and aperiodic CSI-RS resource-set.

In operations as above:
the periodic CSI-RS resources can be used to generate any report type,
the semi-persistent and periodic CSI-RS resources can be used to generate semi-persistent CSI reports, and
the aperiodic CSI-RS can only be utilized only to generate the aperiodic report.

### Frequency-Granularity

The CSI Report Setting also defines which part of the bandwidth the CSI should correspond to, and in addition, what granularity in frequency the CSI should have. To accomplish this, the bandwidth of a BWP is divided into a number of subbands.

All CSI-RS resources within one set are configured with same density and same nrofPorts, where NrofPorts define a number of CSI-RS port(s). Except for the NZP CSI-RS resources used for interference measurement.

For semi-persistent and aperiodic CSI-RS, the actual triggering of CSI-RS transmission is per CSI-RS resource-set via either MAC CE or DCI. And a resource set can be used as part of UE report configurations describing what to be measured and, correspondingly, which measurement reporting are to be done by the UE. Specifically, if a CSI-RS resource-set is configured as ‘aperiodic’ by RRC, the CSI-RS resource set configuration includes a slot offset, a periodicTriggeringOffset which defines the time interval between the triggering DCI and the CSI-RS transmission.

For A-CSI reporting up to 16 different reporting settings can be triggered with single DCI (e.g. for multiple component carriers) while SP-CSI reporting can trigger only one report setting with a single DCI. In order to trigger several SP-CSI reports (each in different slots), multiple DCIs are needed.

### Some Background on Beam Management

Rel17 introduced a unified TCI framework meaning that TCI states so far providing QCL assumptions for the reception of DL signals and channels would be used also to provide spatial sources for the transmission of UL signals and channels to determine UL TX spatial filter. Furthermore, the unified TCI framework defines the concept of indicated TCI state. That means that one or multiple (in case of multi-TRP for instance) of the configured TCI states is/are indicated TCI state(s) at a time. The indicated TCI state can be joint DL and UL TCI state or separate DL and separate UL TCI states. Indicated TCI state provides QCL source (DL) and spatial source (UL) for the set of downlink signals and channels and for the set of uplink signals and channels, respectively. In Rel17 there can be one indicated joint DL and UL or one indicated DL and one indicate UL TCI state for the UE.

Unified TCI framework is expected to be extended in Rel18 so that there can be then multiple indicated DL and UL TCI states.

Standards at the time of this application provide support for both UE non-group and group-based beam reporting schemes. The network can configure up to four CRIs/beams with L1-RSRP values to be reported (via PUCCH or PUSCH).

As previously mentioned, UE-initiated or event-based CSI reporting and/or beam switch is a strong candidate for discussions regarding standards at the time of this application.

In example embodiments of this invention, there is a focus on the aspects related to the UL resources to configure/define/indicate the UE with in order to provide the gNB with information related to an event related to beam/CSI (or any other events, such as related to MPE, etc.) occurring at the UE. The proposed solutions and aspects should be built on top of the existing specifications for CSI measurements and report framework.

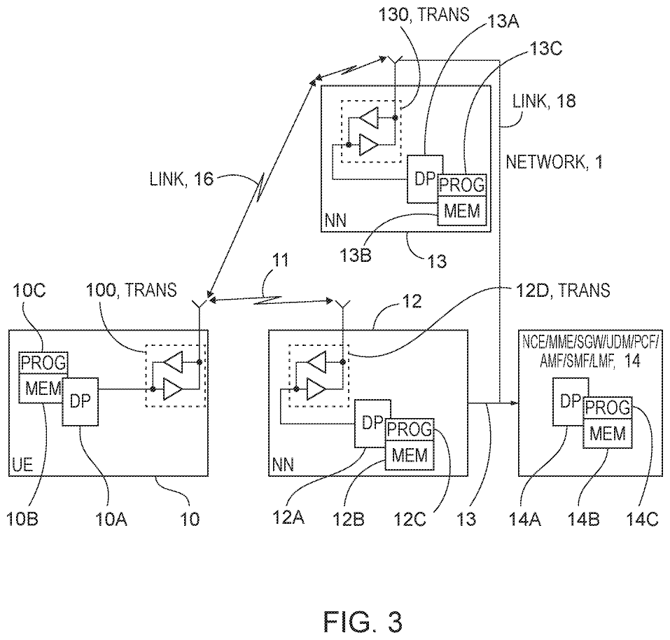

Before describing the example embodiments as disclosed herein in detail, reference is made to FIG. 3 for illustrating a simplified block diagram of various electronic devices that are suitable for use in practicing the example embodiments of this invention.

FIG. 3 shows a block diagram of one possible and non-limiting exemplary system in which the example embodiments may be practiced.

In FIG. 3, a user equipment (UE) 10 is in wireless communication with a wireless network 1 or network, 1 as in FIG. 3. The wireless network 1 or network 1 as in FIG. 3 can comprise a communication network such as a mobile network e.g., the mobile network 1 or first mobile network as disclosed herein. Any reference herein to a wireless network 1 as in FIG. 3 can be seen as a reference to any wireless network as disclosed herein. Further, the wireless network 1 as in FIG. 3 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11 or 16.

The NN 12 (NR/5G/6G Node B, an evolved NB, or LTE device) is a network node such as a master or secondary node base station (e.g., for NR or LTE long term evolution) that communicates with devices such as NN 13 and UE 10 of FIG. 3. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 16 or link 18. Further, the link 11, link 16 and/or any other link may be wired or wireless or both and may implement, e.g., an X2 or Xn interface. Further the link 11 and/or link 16 and/or link 18 may be through other network devices such as, but not limited to an NCE/MME/SGW/UDM/PCF/AMF/SMF/LMF 14 device as in FIG. 3. The NN 12 may perform functionalities of an MME (Mobility Management Entity) or SGW (Serving Gateway), such as a User Plane Functionality, and/or an Access Management functionality for LTE and similar functionality for 5G or 6G.

The NN 13 can be for WiFi or Bluetooth or other wireless device associated with a mobility function device such as an AMF or SMF, further the NN 13 may comprise a NR/5G/6G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 16 or link 18 or another link. The link 16 or link 18 as shown in FIG. 3 can be used for communication with the NN12. These links maybe wired or wireless or both and may implement, e.g., an X2 or Xn interface. Further, as stated above the link 11 and/or link 16 and/or link 18 may be through other network devices such as, but not limited to an NCE/MME/SGW device such as the NCE/MME/SGW/UDM/PCF/AMF/SMF/LMF 14 of FIG. 3.

The one or more buses of the device of FIG. 3 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 3 shows a network nodes such as NN 12 and NN 13, any of these nodes may can incorporate or be incorporated into an eNodeB or eNB or gNB such as for LTE and NR, and would still be configurable to perform example embodiments.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G, 6G, and/or NR operations in addition to or instead of other standard operations at the time of this application. The NCE/MME/SGW/UDM/PCF/AMF/SMF/LMF 14 is configurable to perform operations in accordance with example embodiments in any of an LTE, NR, 5G, 6G, and/or any standards based communication technologies being performed or discussed at the time of this application. In addition, it is noted that the operations in accordance with example embodiments, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or link 16 and/or link 18. In accordance with the example embodiments these network interfaces can include X2 and/or Xn interfaces for use to perform the example embodiments. The one or more memories MEM 14B include computer program code PROG 14C. The one or more memories MEM14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments.

It is noted that that the NN 12 and/or NN 13 and/or UE 10 can be configured (e.g. based on standards implementations etc.) to perform functionality of a Location Management Function (LMF). The LMF functionality may be embodied in any of these network devices or other devices associated with these devices. In addition, an LMF such as the LMF of the MME/SGW/UDM/PCF/AMF/SMF/LMF 14 of FIG. 3, as at least described below, can be co-located with UE 10 such as to be separate from the NN 12 and/or NN 13 of FIG. 3 for performing operations in accordance with example embodiments as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

In general, various embodiments of any of these devices can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of any of these devices can be used with a UE vehicle, a High Altitude Platform Station, or any other such type node associated with a terrestrial network or any drone type radio or a radio in aircraft or other airborne vehicle or a vessel that travels on water such as a boat.

As similarly stated above, some example embodiments of this invention, are based on aspects related to the UL resources to configure/define/indicate the UE with in order to provide the gNB with information related to an event related to beam/CSI (or any other events, such as related to MPE, etc.) occurring at the UE. The proposed solutions and aspects should be built on top of the existing specifications for CSI measurements and report framework.

In one proposed solution in accordance with example embodiments of the invention:
UE is configured with at least one UL resource to be associated with or included in a CSI report configuration (CSI-ReportConfig) used for an event that the UE is configured to determine its occurrence based at least partially on measurements corresponding to the CSI report configuration, where this at least one UL resource is used by the UE to send to the gNB information related to the event when it occurs; and
The at least one UL resource may be periodic or semi-persistent PUCCH resource(s) (e.g., configured with a certain periodicity and offset etc.), or even aperiodic, where the UE determines/considers it as activated or valid (to be used) when the (corresponding) CSI report configuration is triggered/indicated/activated for the UE. Alternatively, or additionally, the UE determines/considers it as activated or valid when event-based reporting/triggering is activated or indicated.

The at least one UL resource may become active a period of time, or an offset, after the CSI report is triggered or activated-where this triggering may be done via DCI, MAC CE, and/or RRC. The reference point for this period of time or offset may be the PDCCH or PDSCH carrying the DCI/MAC CE triggering the CSI report configuration.

In a variant in accordance with example embodiments of the invention, the UE may consider the at least one UL resource as active once the event occurs.

In accordance with example embodiments of the invention, the UE may determine/consider that the at least one UL resource becomes invalid or inactive when the CSI report configuration is deactivated or not active. Alternatively, or additionally, the UE determines/considers it as invalid or inactive when event-based reporting/triggering is deactivated or is not valid anymore.

In accordance with example embodiments of the invention, the UE may be configured/indicated to use the at least one UL resource for carrying one or both of the following two information when the event occurs: (i) that the event has occurred, and (ii) beam/CSI related report; these can be uplink control information (UCI). In this case, as an example, the UE may be configured to separately encode the two information if both are configured to be reported/multiplexed at a time. The number of bits each information consumes may be configured for the UE via RRC.

The UE may be configured to separately encode different parts of the information, wherein a number of bits the information or each part of the information consumes is configured or indicated for the network device via medium access control control element, downlink control information or radio resource control signaling.

Different/separate UL resources/transmissions may be used to send information (i) and information (ii) above. In this case, a time offset may be defined between the resources. For instance, a first resource in a first slot is for carrying (i) and a second resource in a second slot is for carrying (ii).

Although a focus is on indicating that event has occurred, the UE may also be configured to indicate that the event has not occurred (yet) e.g., after a given period of time or after a timer expires where the reference point in time (i.e., the timer is (re-)started) may be the activation/indication of the corresponding CSI report configuration.

In accordance with example embodiments of the invention, the at least one UL resource may be the UL resource(s) the UE is configured/indicated to carry the CSI/beam report into.

Here, the at least one UL resource may consist in two (or more) resources (which may or may not be periodic or semi-persistent): the first resource corresponds to or is associated with a first CSI-RS resource set/group and the second resource corresponds to or is associated with a second CSI-RS resource set/group. An event may be determined to occur by the UE based on (measurements on) each CSI-RS resource set/group separately, or by considering both sets/groups or resources from both sets/groups.

In accordance with example embodiments of the invention, each resource or CSI-RS resource set/group may correspond to one or more of: a TRP, CORESETPoolIndex, SRS resource set, PCI (physical cell identity).

This would then allow, in one possibility, to detect the event for each TRP separately. Or to also detect a joint event across TRPs.

In accordance with example embodiments of the invention, the event may be one or more of the following:
A (UE) decision on TCI state change or beam switch,
A change of one or more of a number of best/preferred beams (these beams are the ones that the UE would select and report if configured to do so),
A change of one or more of a number of best/preferred beam pairs (these beam pairs are the ones that the UE would select and report if configured to do so)
beam/TCI state quality-related condition is satisfied, which may be based on measurements on beams/TCI states. For example, if RSRP measurement for at least one beam or TCI state is below or above a threshold.
A change of at least one CSI quantity,
Maximum permissible exposure (MPE) value above a certain threshold.

In accordance with example embodiments of the invention, the information may consist of at least one of the following:
Indication that the event has occurred;
Beam reporting or triggering beam reporting;
Beam or TCI state update/change or triggering such update/change;
CSI update/change or triggering such update/change; and/or
Measurements for one or more beams (or TCI states), such as RSRP or SINR, below (or even above) a threshold.

The least one UL resource may be any of: PUCCH resource, PUSCH resource, SRS resource. The at least one UL resource may be SR (scheduling request) like resource.

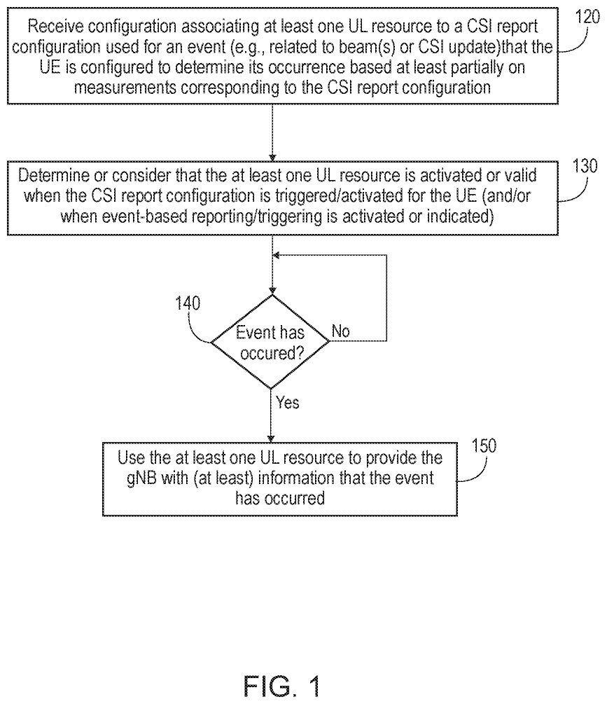

FIG. 1 shows an illustration of some of the high-level aspects of a proposed solutions in accordance with example embodiments of the invention.

As shown in block 110 of FIG. 1 there is receiving configuration associating at least one UL resource to a CSI report configuration used for an event (e.g., related to beams of CSI update) that the UE is configured to determine its occurrence based at least partially on measurements corresponding to the CSI report configuration. As shown in block 120 of FIG. 1 there is determining or considering that the at least one UL resource is activated or valid when the CSI report configuration is triggered or activated for the UE (and/or when event-based reporting or triggering is activated or indicated. As shown in block 130 of FIG. 1 there is determining whether the event has occurred. If No at block 130 there block 130 is repeated. If ‘yes’ at block 130 then as shown in block 140 of FIG. 1 there is using the at least one UL resource to provide the gNB with (at least) information that the event has occurred.

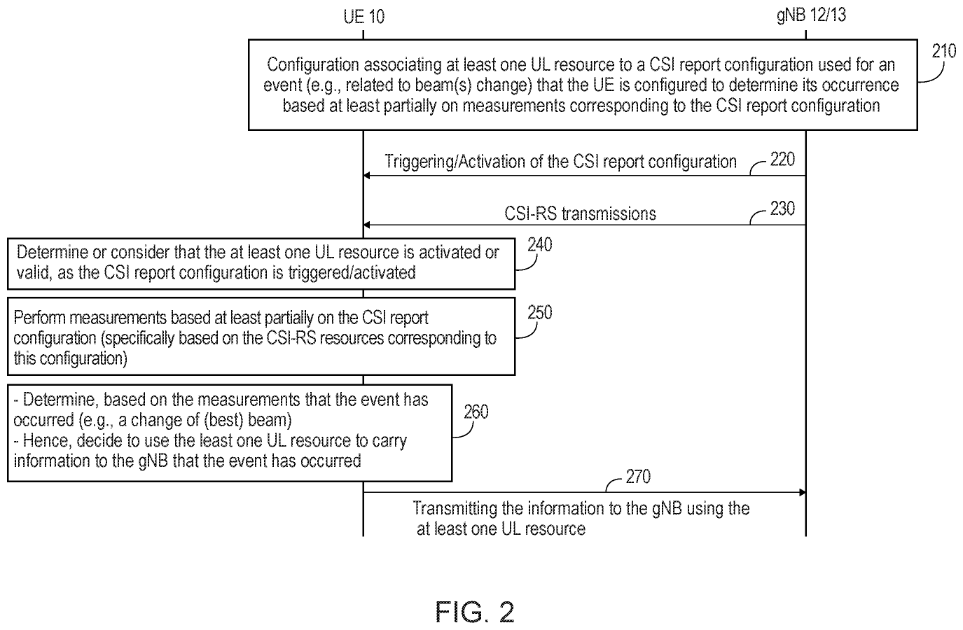

FIG. 2 shows a signaling diagram of some of the high-level aspects of another proposed solutions in accordance with example embodiments of the invention;

As shown in FIG. 2 there is communication between the UE 10 and the gNB 12 and/or 13. As shown in block 210 of FIG. 2 there is communicating a configuration associating at least one UL resource to a CSI report configuration used for an event (e.g., related to beam(s) change) that the UE is configured to determine its occurrence based at least partially on measurements corresponding to the CSI report configuration. As shown in step 220 of FIG. 2 there is triggering or activation of the CSI configuration between the gNB 12 and/or 13 and the UE 10. As shown in step 230 of FIG. 2 there is CSI-RS transmissions between the gNB 12 and/or 13 and the UE 10. As shown in block 240 of FIG. 2 there is determining or considering that the at least one UL resource is activated or valid, as the CSI report configuration is triggered or activated. As shown in block 250 of FIG. 2 there is performing measurements based at least partially on the CSI report configuration (specifically based on the CSI-RS resources corresponding to the CSI report configuration. As shown in block 260 of FIG. 2 there is determining, based on measurements that the event has occurred (e.g., a change of [best] beam), and then hence decide to use the at least one UL resource to carry information to the gNB that the event has occurred. Then as shown in step 270 of FIG. 2 there is transmitting between the UE 10 and the gNB 12 and/or 13 the information using the at least one UL resource.

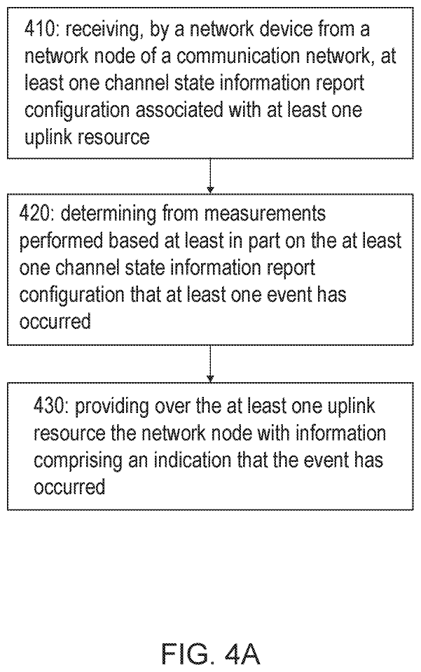

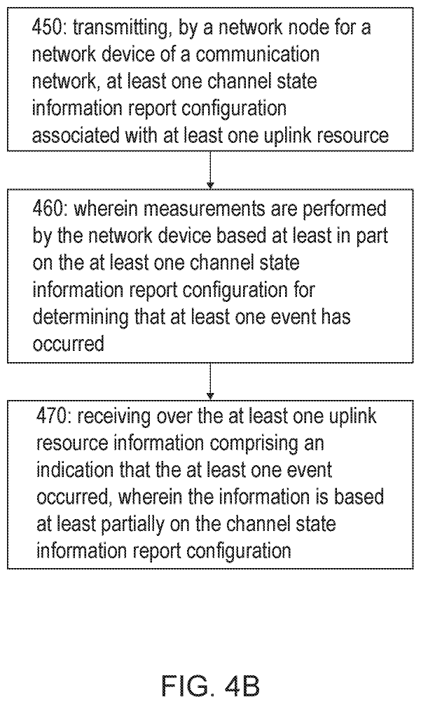

FIG. 4A and FIG. 4B each show a method in accordance with example embodiments of the invention which may be performed by an apparatus.

FIG. 4A illustrates operations which may be performed by a device such as, but not limited to, a device such as a network device (e.g., the UE 10 as in FIG. 3). As shown in step 410 of FIG. 4A there is receiving, by a network device from a network node of a communication network, at least one channel state information report configuration associated with at least one uplink resource. As shown in block 420 of FIG. 4A there is determining from measurements performed based at least in part on the at least one channel state information report configuration that at least one event has occurred. Then as shown in block 430 of FIG. 4A there is, providing over the at least one uplink resource the network node with information comprising an indication that the event has occurred.

In accordance with the example embodiments as described in the paragraph above, there is performing the measurements based at least in part on the at least one channel state information report configuration, wherein the performing is based on reference signal resources corresponding to the at least one channel state information report configuration; and determining based on the measurements that the at least one event has occurred.

In accordance with the example embodiments as described in the paragraphs above, wherein there is determining the at least one uplink resource is active based on the at least one channel state information report configuration being triggered or activated for the network device.

In accordance with the example embodiments as described in the paragraphs above, wherein the at least one uplink resource is configured with at least one of a periodicity or offset, or the at least one uplink resource is aperiodic.

In accordance with the example embodiments as described in the paragraphs above, wherein the at least one uplink resource is triggered or activated for a period of time, or after a timer expires, or a period of time or an offset after the at least one channel state information report configuration is triggered or activated, or after or when the at least one channel state information report configuration is triggered or activated, or after or when the at least one event has occurred.

In accordance with the example embodiments as described in the paragraphs above, wherein the triggering or activating is performed via at least one of: a downlink control information, a medium access control control element, or radio resource control signaling.

In accordance with the example embodiments as described in the paragraphs above, wherein a reference point for the at least one of a period of time or an offset is based on a physical downlink control channel or a physical downlink shared channel carrying a downlink control information or a medium access control control element triggering the at least one channel state information report configuration.

In accordance with the example embodiments as described in the paragraphs above, wherein the information provided over the at least one uplink resource to the network node comprises at least one of the at least one event occurring, or a beam information report, or a channel state information report.

In accordance with the example embodiments as described in the paragraphs above, wherein when at least one of the at least one event occurs, the network device is configured to use the at least one uplink resource for carrying information of at least one of: that at least one of the at least one event has occurred, or a beam report or channel state information report, a beam related report or channel state information related report.

In accordance with the example embodiments as described in the paragraphs above, wherein the information comprises uplink control information.

In accordance with the example embodiments as described in the paragraphs above, wherein the network device is configured to separately encode different parts of the information, wherein a number of bits the information or each part of the information consumes is configured or indicated for the network device via medium access control control element, downlink control information or radio resource control signaling.

In accordance with the example embodiments as described in the paragraphs above, wherein the information is encoded to provide separate information of more than one event, and wherein a number of bits each separate information is configured or indicated for the network device via medium access control control element, downlink control information or radio resource control signaling.

In accordance with the example embodiments as described in the paragraphs above, wherein different or separate uplink resources are used to provide the network node with different parts of the information.

In accordance with the example embodiments as described in the paragraphs above, wherein the information comprises information of one or more of: at least one first event occurring, at least one second event not occurring, a beam report or a channel state information report for the at least one first event, a beam report or a channel state information report for the at least one second event, at least one event occurring, and an indication of a corresponding cell or a corresponding component carrier, at least one event not occurring, and an indication of a corresponding cell or a corresponding component carrier, at least one event occurring, and an indication of a corresponding channel state information report configuration, at least one event not occurring, an indication of a corresponding channel state information report configuration, an indication that the at least one event has occurred, a beam reporting or a triggering of a beam reporting, a beam or transmission configuration indicator state update or change, or triggering beam or transmission configuration indicator state update or change, a channel state information update or change, or triggering channel state information update or change, or measurements for one or more beams or transmission configuration indicator states, or a reference signal received power or signal to interference noise ratio being below or above a threshold, or a triggering of or a request for beam refinement, or at least one best or preferred beam or at least one best or preferred transmission configuration indicator, or at least one event occurring, and an indication of a corresponding reference signal resource group, or at least one event not occurring, and an indication of a corresponding reference signal resource group, or at least one event occurring, and an indication of a corresponding control resource set pool index or a corresponding physical cell identity or a corresponding sounding reference signal resource set or a corresponding transmission-reception point or a corresponding group of beams or a corresponding group of reference signals, or at least one event not occurring, and an indication of a corresponding control resource set pool index or a corresponding physical cell identity or a corresponding sounding reference signal resource set or a corresponding transmission-reception point or a corresponding group of beams or a corresponding group of reference signals.

In accordance with the example embodiments as described in the paragraphs above, wherein a time offset is defined between the resources.

In accordance with the example embodiments as described in the paragraphs above, wherein the at least one uplink resource comprises two or more resources, wherein a time offset is defined between the resources, and wherein a first resource in a first slot or a first sub-slot is for carrying a first part of the information and a second resource in a second slot or a second sub-slot is for carrying a second part of the information.

In accordance with the example embodiments as described in the paragraphs above, wherein a first resource in a first slot or a first sub-slot is for carrying a first separate information and a second resource in a second slot or a second sub-slot is for carrying second separate information.

In accordance with the example embodiments as described in the paragraphs above, wherein the at least one uplink resource comprises two or more resources, wherein the first resource corresponds to or is associated with a first channel state information reference signal resource set or group and the second resource corresponds to or is associated with a second channel state information reference signal resource set or group.

In accordance with the example embodiments as described in the paragraphs above, wherein at least one event is determined to have occurred by the network device based on measurements performed for each reference signal resource set or group separately, or by jointly considering both resource sets or groups.

In accordance with the example embodiments as described in the paragraphs above, wherein each uplink resource or channel state information reference signal resource set or group corresponds to or is associated with one or more of: a transmission-reception point, control resource set pool index, a sounding reference signal resource set, a physical cell identity.

In accordance with the example embodiments as described in the paragraphs above, wherein when at least one event is determined to have occurred based on measurements performed for a resource set or group, the apparatus is caused to use at least one uplink resource associated with the resource set or group to provide the information or at least part of the information to the network node.

In accordance with the example embodiments as described in the paragraphs above, wherein the at least one event comprises one or more of: a network device decision on transmission configuration indicator state change or a beam switch, a change of one or more of a number of best or preferred beams for reporting, a change of one or more of a number of best or preferred beam pairs for reporting, a beam or transmission configuration indicator state quality-related condition is satisfied, a change of at least one channel state information quantity, or a maximum permissible exposure value is above a certain threshold.

In accordance with the example embodiments as described in the paragraphs above, wherein the at least one event comprises one or more of: a change in a best beam, or a change in a best channel state information reference signal resource indicator (CRI), or a change in a best synchronization signal block resource indicator (SSBRI), or a change in a set of one or more best beams, or a change in a set of one or more best channel state information reference signal resource indicators (CRIs), or a change in a set of one or more best synchronization signal block resource indicators (SSBRIs), or a change of at least one of a set of best beam pairs or channel state information reference signal resource indicator (CRI) pairs, or a reference signal received power (RSRP) value associated with a best beam or at least one of the set of best beams or at least one beam pair is lower or higher than a threshold or changes more than an offset value, or a value related to reference signal received power (RSRP) values associated with at least part of the set of best beams or at least part of least one beam pair is lower or higher than a threshold or changes more than an offset value, or a measurement value of at least one reference signal (RS) associated with a transmission configuration indicator (TCI) state is higher or lower than a measurement value of a reference signal (RS) associated with another transmission configuration indicator state by a threshold, or a reference signal received power (RSRP) value associated with a transmission configuration indicator state is lower.

In accordance with the example embodiments as described in the paragraphs above, wherein there is determining that the at least one uplink resource is invalid or inactive when the at least one channel state information report configuration is deactivated or not active, or determining that the at least one uplink resource is invalid or inactive when event-based reporting or triggering is deactivated or is not valid.

In accordance with the example embodiments as described in the paragraphs above, wherein the at least one channel state information report configuration corresponds to or includes or can be replaced by at least one of: one or more demodulation reference signal configurations, or one or more physical downlink shared channel configurations, one or more physical downlink shared channel configurations, or one or more channel state information report sub-configuration each of which corresponding to one or more of the at least one events or to at least one condition.

In accordance with the example embodiments as described in the paragraphs above, wherein one or more events of the at least one event is associated with a dedicated one or more uplink resources corresponding to the at least one channel state information report configuration.

A non-transitory computer-readable medium (MEM 10B as in FIG. 3) storing program code (PROG 10C of as in FIG. 3), the program code executed by at least one processor (DP 10A as in FIG. 3) to perform the operations as at least described in the paragraphs above.

In accordance with an example embodiment of the invention as described above there is an apparatus comprising: means for receiving (one or more transceivers 10D; MEM 10B; PROG 10C; and DP 10A as in FIG. 3), by a network device (UE 10 as in FIG. 3) from a network node (NN 12 and/or NN 13 as in FIG. 3) of a communication network (Network 1 as in FIG. 3), at least one channel state information report configuration associated with at least one uplink resource; means for determining (one or more transceivers 10D; MEM 10B; PROG 10C; and DP 10A as in FIG. 3) from measurements performed based at least in part on the at least one channel state information report configuration that at least one event has occurred; and means for providing (one or more transceivers 10D; MEM 10B; PROG 10C; and DP 10A as in FIG. 3) over the at least one uplink resource the network node with information comprising an indication that the event has occurred.

In the example aspect of the invention according to the paragraph above, wherein at least the means for receiving, determining, and using comprises a non-transitory computer readable medium [MEM 10B as in FIG. 3] encoded with a computer program [PROG 10C as in FIG. 3] executable by at least one processor [DP 10A as in FIG. 3].

FIG. 4B illustrates operations which may be performed by a device such as, but not limited to, such as network node (e.g., the NN 12 and/or NN 13 as in FIG. 3). As shown in step 450 of FIG. 4B there is transmitting, by a network node for a network device of a communication network, at least one channel state information report configuration associated with at least one uplink. As shown in step 460 of FIG. 4B wherein measurements are performed by the network device based at least in part on the at least one channel state information report configuration for determining that at least one event has occurred. Then as shown in step 470 of FIG. 4 B there is receiving over the at least one uplink resource information comprising an indication that the at least one event occurred, wherein the information is based at least partially on the channel state information report configuration.

In accordance with the example embodiments as described in the paragraph above, wherein the measurements are performed based at least in part on one of the at least one channel state information report configuration or reference signal resources corresponding to the at least one channel state information report configuration.

In accordance with the example embodiments as described in the paragraphs above, wherein the at least one uplink resource is triggered or activated for a period of time, or after a timer expires, or a period of time or an offset after the at least one channel state information report configuration is triggered or activated, or after or when the at least one channel state information report configuration is triggered or activated, or after or when the at least one event has occurred.

In accordance with the example embodiments as described in the paragraphs above, wherein the at least one uplink resource is configured with at least one of a periodicity or offset, or the at least one uplink resource is aperiodic.

In accordance with the example embodiments as described in the paragraphs above, wherein the at least one uplink resource is triggered or activated for a period of time, or after a timer expires, or a period of time or an offset after the at least one channel state information report configuration is triggered or activated, or after or when the at least one channel state information report configuration is triggered or activated, or after or when the at least one event has occurred.

In accordance with the example embodiments as described in the paragraphs above, wherein the triggering or activating is performed via at least one of: a downlink control information, a medium access control control element, or radio resource control.

In accordance with the example embodiments as described in the paragraphs above, wherein a reference point for the at least one of a period of time or an offset is based on a physical downlink control channel or a physical downlink shared channel carrying a downlink control information or a medium access control control element triggering the at least one channel state information report configuration.

In accordance with the example embodiments as described in the paragraphs above, wherein the information received over the at least one uplink resource.

In accordance with the example embodiments as described in the paragraphs above, wherein the information comprises at least one of the at least one event occurring, or a beam information report, or a channel state information report.

In accordance with the example embodiments as described in the paragraphs above, wherein the information is encoded to provide separate information of more than one event, wherein the more than one event is multiplexed in time.

In accordance with the example embodiments as described in the paragraphs above, wherein a number of bits each separate information is configured or indicated for the network device via medium access control control element, downlink control information or radio resource control signaling.

In accordance with the example embodiments as described in the paragraphs above, wherein different or separate uplink resources are used to receive the information.

In accordance with the example embodiments as described in the paragraphs above, wherein the information comprises information of one or more of: at least one first event occurring, at least one second event not occurring, a beam report or a channel state information report for the at least one first event, a beam report or a channel state information report for the at least one second event, at least one event occurring, and an indication of a corresponding cell or a corresponding component carrier, at least one event not occurring, and an indication of a corresponding cell or a corresponding component carrier, at least one event occurring, and an indication of a corresponding CSI report configuration, at least one event not occurring, an indication of a corresponding CSI report configuration, an indication that the at least one event has occurred, a beam reporting or a triggering of a beam reporting, a beam or transmission configuration indicator state update or change, or triggering beam or transmission configuration indicator state update or change, a channel state information update or change, or triggering channel state information update or change, or measurements for one or more beams or transmission configuration indicator states, or a reference signal received power or signal to interference noise ratio being below or above a threshold, or a triggering of or a request for beam refinement, or at least one best or preferred beam or at least one best or preferred transmission configuration indicator, or at least one event occurring, and an indication of a corresponding reference signal resource group, or at least one event not occurring, and an indication of a corresponding reference signal resource group, or at least one event occurring, and an indication of a corresponding control resource set pool index or a corresponding physical cell identity or a corresponding sounding reference signal resource set or a corresponding transmission-reception point or a corresponding group of beams or a corresponding group of reference signals, or at least one event not occurring, and an indication of a corresponding control resource set pool index or a corresponding physical cell identity or a corresponding sounding reference signal resource set or a corresponding transmission-reception point or a corresponding group of beams or a corresponding group of reference signals.

In accordance with the example embodiments as described in the paragraphs above, wherein a time offset is defined between the resources.

In accordance with the example embodiments as described in the paragraphs above, wherein the at least one uplink resource comprises two or more resources, wherein a time offset is defined between the resources, and wherein a first resource in a first slot or a first sub-slot is for carrying a first part of the information and a second resource in a second slot or a second sub-slot is for carrying a second part of the information.

In accordance with the example embodiments as described in the paragraphs above, wherein each at least one uplink resource corresponds to one or more of a transmission-reception point, control resource set pool index, an sounding reference signal resource set, or a physical cell identity, wherein the corresponding enables detection of the at least one event for each transmission-reception point separately or jointly across a transmission-reception point

In accordance with the example embodiments as described in the paragraphs above, wherein a first resource in a first slot is for carrying a first separate information and a second resource in a second slot is for carrying second separate information.

In accordance with the example embodiments as described in the paragraphs above, wherein each at least one uplink resource corresponds to one or more of a transmission-reception point of an antenna, control resource set pool index, an SRS resource set, or a physical cell identity.

In accordance with the example embodiments as described in the paragraphs above, wherein the corresponding enables detection of the at least one event for each transmission-reception point of an antenna separately or jointly across a transmission-reception point.

In accordance with the example embodiments as described in the paragraphs above, wherein the at least one event comprises: a network device decision on transmission configuration indicator state change or abeam switch, a change of one or more of a number of best or preferred beams for reporting, a change of one or more of a number of best or preferred beam pairs for reporting, a beam or transmission configuration indicator state quality-related condition is satisfied, a change of at least one channel state information quantity, or a maximum permissible exposure value is above a certain threshold.

In accordance with the example embodiments as described in the paragraphs above, wherein the information comprises at least one of: an indication that the event has occurred, beam reporting or triggering beam reporting, beam or transmission configuration indicator state update or change or triggering such an updateorchange, channel state information update or change or triggering such updateorchange, or measurements for one or more beams or transmission configuration indicator states, such as reference signal received power or signal to interference noise ratio below or above a threshold.

In accordance with the example embodiments as described in the paragraphs above, wherein the at least one channel state information report configuration corresponds to or includes or can be replaced by at least one of: one or more demodulation reference signal configurations, or one or more physical downlink shared channel configurations, one or more physical downlink shared channel configurations, or one or more channel state information report sub-configuration each of which is corresponding to one or more of the at least one events or to at least one condition.

In accordance with the example embodiments as described in the paragraphs above, wherein one or more events of the at least one event is associated with a dedicated one or more uplink resources corresponding to the at least one channel state information report configuration.

A non-transitory computer-readable medium (MEM 12B and/or MEM 13B as in FIG. 3) storing program code (PROG 12C and/or PROG 13C as in FIG. 3), the program code executed by at least one processor (DP 12A and/or DP 13A as in FIG. 3) to perform the operations as at least described in the paragraphs above.

In accordance with an example embodiment of the invention as described above there is an apparatus comprising: means for determining (one or more transceivers 12D and/or 13D, DP 12A and/or DP 13A, DP 12F and/or DP 13F, PROG 12C and/or PROG 13C, and MEM 12B and/or MEM 13B as in FIG. 3), by a network node (NN 12 and/or NN 13 as in FIG. 3) for a network device (UE 10 as in FIG. 3)of a communication network, a channel state information reporting configuration associated with at least one uplink resource, wherein the at least one channel state information report configuration is configured (one or more transceivers 12D and/or 13D, DP 12A and/or DP 13A, DP 12F and/or DP 13F, PROG 12C and/or PROG 13C, and MEM 12B and/or MEM 13B as in FIG. 3) to be triggered based on at least one event occurring; and means for receiving (one or more transceivers 12D and/or 13D, DP 12A and/or DP 13A, DP 12F and/or DP 13F, PROG 12C and/or PROG 13C, and MEM 12B and/or MEM 13B as in FIG. 3) over the at least one uplink resource information comprising an indication that the event occurred, wherein the information is based on the channel state information report configuration.

In the example aspect of the invention according to the paragraph above, wherein at least the means for determining and receiving comprises a non-transitory computer readable medium [MEM 12B and/or MEM 13B as in FIG. 3] encoded with a computer program [PROG 12C and/or PROG 13C as in FIG. 3] executable by at least one processor [DP 12A and/or DP 13A as in FIG. 3].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention, there is adequate circuitry for performing at least novel operations in accordance with example embodiments of the invention as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-42. (canceled)

43. An apparatus, comprising:
at least one processor; and
at least one non-transitory memory storing instructions, that when executed by the at least one processor, cause the apparatus at least to:
receive, from a network node of a communication network, at least one channel state information report configuration associated with at least one uplink resource;
determine from measurements performed based at least in part on the at least one channel state information report configuration that at least one event has occurred; and
provide over the at least one uplink resource the network node with information comprising an indication that the event has occurred.

44. The apparatus of claim 43, wherein the at least one non-transitory memory storing instructions is executed by the at least one processor to cause the apparatus to:
perform the measurements based at least in part on the at least one channel state information report configuration,
wherein the performing is based on reference signal resources
corresponding to the at least one channel state information report configuration; and
determine based on the measurements that the at least one event has occurred.

45. The apparatus of claim 43, wherein the at least one non-transitory memory storing instructions is executed by the at least one processor to cause the apparatus to:
determine the at least one uplink resource is active based on the at least one channel state information report configuration being triggered or activated for the apparatus.

46. The apparatus of claim 43, wherein the at least one uplink resource is configured with at least one of a periodicity or offset, or the at least one uplink resource is aperiodic.

47. The apparatus of claim 46, wherein the at least one uplink resource is triggered or activated for a period of time, or after a timer expires, or a period of time or an offset after the at least one channel state information report configuration is triggered or activated, or after or when the at least one channel state information report configuration is triggered or activated, or after or when the at least one event has occurred.

48. The apparatus of claim 47, wherein the triggering or activating is performed via at least one of: a downlink control information, a medium access control control element, or radio resource control signaling.

49. The apparatus of claim 47, wherein a reference point for the at least one of a period of time or an offset is based on a physical downlink control channel or a physical downlink shared channel carrying a downlink control information or a medium access control control element triggering the at least one channel state information report configuration.

50. The apparatus of claim 43, wherein the information provided over the at least one uplink resource to the network node comprises at least one of the at least one event occurring, or a beam information report, or a channel state information report.

51. The apparatus of claim 50, wherein when at least one of the at least one event occurs, the apparatus is configured to use the at least one uplink resource for carrying information of at least one of:
that at least one of the at least one event has occurred,
a beam report, or
a channel state information report,
a beam related report, or
a channel state information related report.

52. The apparatus of claim 51, wherein the information comprises uplink control information.

53. The apparatus of claim 51, wherein the apparatus is configured to separately encode different parts of the information, wherein a number of bits the information or each part of the information consumes is configured or indicated for the apparatus via medium access control control element, downlink control information or radio resource control signaling.

54. The apparatus of claim 50, wherein the information is encoded to provide separate information of more than one event, and wherein a number of bits for each separate information is configured or indicated for the apparatus via medium access control control element, downlink control information or radio resource control signaling.

55. The apparatus of claim 50, wherein different or separate uplink resources are used to provide the network node with different parts of the information.

56. The apparatus of claim 43, wherein the information comprises information of one or more of:
at least one first event occurring,
at least one second event not occurring,
a beam report or a channel state information report for the at least one first event,
a beam report or a channel state information report for the at least one second event,
at least one event occurring, and an indication of a corresponding cell or a corresponding component carrier,
at least one event not occurring, and an indication of a corresponding cell or a corresponding component carrier,
at least one event occurring, and an indication of a corresponding channel state information report configuration,
at least one event not occurring, an indication of a corresponding channel state information report configuration,
an indication that the at least one event has occurred,
a beam reporting or a triggering of a beam reporting,
a beam or transmission configuration indicator state update or change, or triggering beam or transmission configuration indicator state update or change,
a channel state information update or change, or triggering channel state information update or change,
measurements for one or more beams or transmission configuration indicator states,
a reference signal received power or signal to interference noise ratio being below or above a threshold,
a triggering of or a request for beam refinement,
at least one best or preferred beam or at least one best or preferred transmission configuration indicator,
at least one event occurring, and an indication of a corresponding reference signal resource group,
at least one event not occurring, and an indication of a corresponding reference signal resource group,
at least one event occurring, and an indication of a corresponding control resource set pool index or a corresponding physical cell identity or a corresponding sounding reference signal resource set or a corresponding transmission-reception point or a corresponding group of beams or a corresponding group of reference signals, or
at least one event not occurring, and an indication of a corresponding control resource set pool index or a corresponding physical cell identity or a corresponding sounding reference signal resource set or a corresponding transmission-reception point or a corresponding group of beams or a corresponding group of reference signals.

57. The apparatus according to claims 56, wherein when at least one event is determined to have occurred based on measurements performed for the resource set or group, the apparatus is caused to use at least one uplink resource associated with the resource set or group to provide the information or at least part of the information to the network node.

58. A method, comprising:
receiving, by a network device, and from a network node of a communication network, at least one channel state information report configuration associated with at least one uplink resource;
determining from measurements performed based at least in part on the at least one channel state information report configuration that at least one event has occurred; and
providing over the at least one uplink resource the network node with information comprising an indication that the event has occurred.

59. An apparatus, comprising:
at least one processor; and
at least one non-transitory memory storing instructions, that when executed by the at least one processor, cause the apparatus at least to:
transmit, to a network device of a communication network, at least one channel state information report configuration associated with at least one uplink resource,
wherein measurements are performed by the network device based at least in part on the at least one channel state information report configuration for determining that at least one event has occurred; and
receive over the at least one uplink resource information comprising an indication that the at least one event occurred, wherein the information is based at least partially on the channel state information report configuration.

60. The apparatus of claim 59, wherein the measurements are performed based at least in part on one of the at least one channel state information report configuration or reference signal resources corresponding to the at least one channel state information report configuration.

61. The apparatus of claim 59, wherein the at least one uplink resource is triggered or activated for a period of time, or after a timer expires, or a period of time or an offset after the at least one channel state information report configuration is triggered or activated, or after or when the at least one channel state information report configuration is triggered or activated, or after or when the at least one event has occurred.

62. The apparatus of claim 59, wherein the at least one uplink resource is configured with at least one of a periodicity or offset, or the at least one uplink resource is aperiodic.
